(19) United States
(12) Patent Application Publication
(10) Pub. No.: US 2013/0010222 A1
(43) Pub. Date: Jan. 10, 2013

(54) METHOD FOR CUTTING PANEL SUBSTRATE AND SUBSTRATE CUTTING APPARATUS

(75) Inventors: Kuancheng Lee, Shenzhen (CN); Chunliang Lee, Shenzhen (CN); Yahui Chen, Shenzhen (CN)

(73) Assignee: Shenzhen China Star Optoelectronics Technology Co, LTD., Shenzhen (CN)

(21) Appl. No.: 13/380,004

(22) PCT Filed: Sep. 30, 2011
(86) PCT No.: PCT/CN11/80402

§ 371 Date: Dec. 21, 2011

(30) Foreign Application Priority Data
Jul. 6, 2011 (CN) 201110187455.5

(51) Int. Cl. G02F 1/1333; G02F 1/1335

(52) U.S. Cl. 349/58

(57) ABSTRACT

The present invention discloses a liquid crystal display (LCD) device, which comprises: a first substrate and a second substrate opposite to each other, a liquid crystal layer filled between the first substrate and the second substrate, and many main supporting parts which are arranged between the first substrate and the second substrate. A pixel area is arranged on the first substrate; and in the pixel area, the main supporting parts are arranged between two adjacent rows of sub pixels, and in the main supporting parts, one portion of the main supporting parts and the other portion of the main supporting parts are misaligned a distance from each other. When the LCD panel is pressed by an external force or the assembling accuracy of the upper/lower substrates is closed to a design tolerance, it can avoid or reduce the phenomenon of Mura or light leak occurred on the LCD panel.

This application claims priority of a Chinese patent application, with an application number: 201110187455.5 and a title of “Liquid Crystal Display Device”, submitted to the Patent Office of the People's Republic of China on Jul. 6, 2011, and hereby incorporated by reference in its entirety.

### FIELD OF THE INVENTION

The present invention relates to a field of a liquid crystal display (LCD), and more particularly to an LCD device.

### BACKGROUND OF THE INVENTION

A liquid crystal display (LCD) is already become a widely applied display device in various kinds of the electronic equipments, such as mobile telephone, personal digital assistant (PDA), digital camera, computer screen, or notebook computer screen. The LCD comprises a backlight module and an LCD panel, and the LCD panel is assembled by two substrates and a liquid layer between the two substrates. The manufacturing technologies of the LCD are various, and a Polymer Stabilized Vertical Alignment (PSVA) LCD panel is generally used right now.

Recently, in a process of the LCD panel manufacture, pillars are very important in supporting the substrates of the LCD panel. However in the traditional technologies, when the LCD panel is pressed by an external force or the assembling accuracy of the upper/lower substrates is closed to a design tolerance, the pillars at or near the pressed location are possibly detached from a joint under the pillars, so that the LCD panel may occur the phenomenon of “Mura” (Mura means a phenomenon of various traces caused by non-uniform brightness) or light leak. The pillars detached from the joint can not return to a normal jointed condition, and the phenomenon of “Mura” also can not be recovered even thought the external force is removed. It will lower the product level of the LCD panel, even the LCD panel is unable to be sold to customers.

### SUMMARY OF THE INVENTION

The present invention is provides a liquid crystal display (LCD) device which can avoid or reduce the phenomenon of “Mura” or light leak occurred on the LCD panel.

To overcome the above mentioned technology problems, the present invention provides an LCD device, which comprises:

a first substrate and a second substrate opposite to each other, a liquid crystal layer filled between the first substrate and the second substrate, and a plurality of main supporting parts which are arranged between the first substrate and the second substrate;

wherein, a pixel area is arranged on the first substrate; and

in the pixel area, the main supporting parts are arranged between two adjacent rows of sub pixels, and in the main supporting parts, one portion of the main supporting parts and the other portion of the main supporting parts are misaligned a distance from each other.

in the main supporting parts, one portion of the main supporting parts and the other portion of the main supporting parts are misaligned a distance from each other, wherein: in the main supporting parts, two of the adjacent main supporting parts are misaligned a distance from each other.

The main supporting parts arranged between the rows of sub pixels construct rows of the main supporting part; and in two adjacent rows of the main supporting parts, the main supporting parts are aligned to each other without displacement along the perpendicular direction of the rows of the main supporting parts.

The main supporting parts between the rows of sub pixels construct rows of the main supporting part; and in two adjacent rows of the main supporting part, the main supporting parts are misaligned to each other with a displacement along the perpendicular direction of the main supporting parts.

The two misaligned main supporting parts misaligned a distance of 2 to 4 micrometers in the perpendicular direction of the main supporting part.

The LCD device further comprises sub supporting parts, wherein the sub supporting parts are arranged on the first substrate, extended toward to the second substrate, and have a gap with the second substrate.

The first substrate is a color filter substrate, and the sub pixels in the pixel area are R, G, B color filters.

In a row of the main supporting parts between two rows of the adjacent color filters, each two main supporting parts are spaced a distance of two color filters.

In a row of the main supporting parts, there are two of the sub supporting parts arranged between two of the adjacent main supporting parts.

In a row of the main supporting parts, five of the sub supporting parts are arranged between the adjacent main supporting parts.

To carry out the present invention, when the LCD panel is pressed by an external force or the assembling accuracy of the upper/lower substrates is closed to a design tolerance, it can avoid or reduce the phenomenon of Mura or light leak occurred on the LCD panel. Because the main supporting parts in the same row misalign a specific distance, when the external force is removed, the pillars detached from the joint can return to a normal jointed condition to prevent the LCD panel from phenomenon of “Mura” or light leak, or to improve the recovering speed of display of the LCD panel, so as to improve the quality of the LCD panel.

### DESCRIPTION OF THE DRAWINGS

The structure and the technical means adopted by the present invention to achieve the above and other objects can be best understood by referring to the following detailed description of the preferred embodiments and the accompanying drawings. Obviously, the following drawings are merely shown for some embodiments of the present invention. For a person skilled in the art, other drawings can be obtained according these drawings without creative labor.

FIG. 1 is a structural schematic view of a liquid crystal display (LCD) device according to a preferred embodiment of the present invention;

FIG. 2 is a first specific structural schematic view of the LCD device taken along the A-A cross-section according to a preferred embodiment of the present invention;

FIG. 3 is a second specific structural schematic view of the LCD device taken along the A-A cross-section according to a preferred embodiment of the present invention;

FIG. 4 is a third specific structural schematic view of the LCD device taken along the A-A cross-section according to a preferred embodiment of the present invention;

FIG. 5 is a forth specific structural schematic view of the LCD device taken along the A-A cross-section according to a preferred embodiment of the present invention;

FIG. 6 is a fifth specific structural schematic view of the LCD device taken along the A-A cross-section according to a preferred embodiment of the present invention; and

FIG. 7 is a sixth specific structural schematic view of the LCD device taken along the A-A cross-section according to a preferred embodiment of the present invention;

### DETAILED DESCRIPTION OF THE PREFERRED EMBODIMENTS

According to a problem of a traditional liquid crystal display (LCD) device, when the LCD panel is pressed by an external force or the assembling accuracy of the upper/lower substrates is closed to a design tolerance, the LCD panel may occur the phenomenon of “Mura” or light leak, the present invention provides a liquid crystal display (LCD) device which can efficiently solve the problem.

FIG. 1 is a structural schematic view of an LCD device according to a preferred embodiment of the present invention. As shown in FIG. 1, an LCD device comprises:

A first substrate 1 and a second substrate 2 opposite to each other, a liquid crystal layer 3 filled between the first substrate 1 and the second substrate 2, and a plurality of main supporting parts 4 which are arranged between the first substrate 1 and the second substrate 2 extended from one substrate to the other substrate.

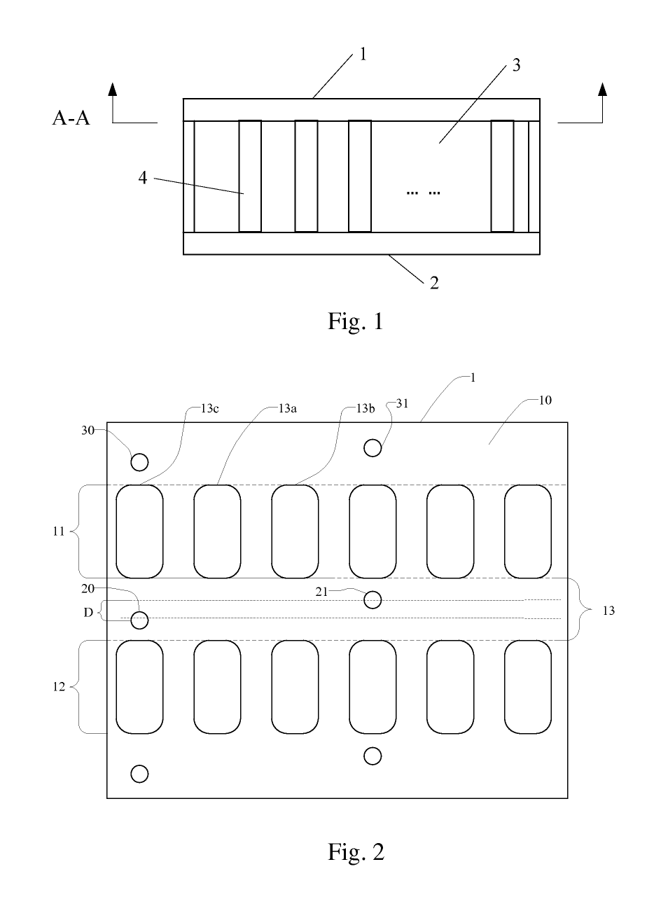

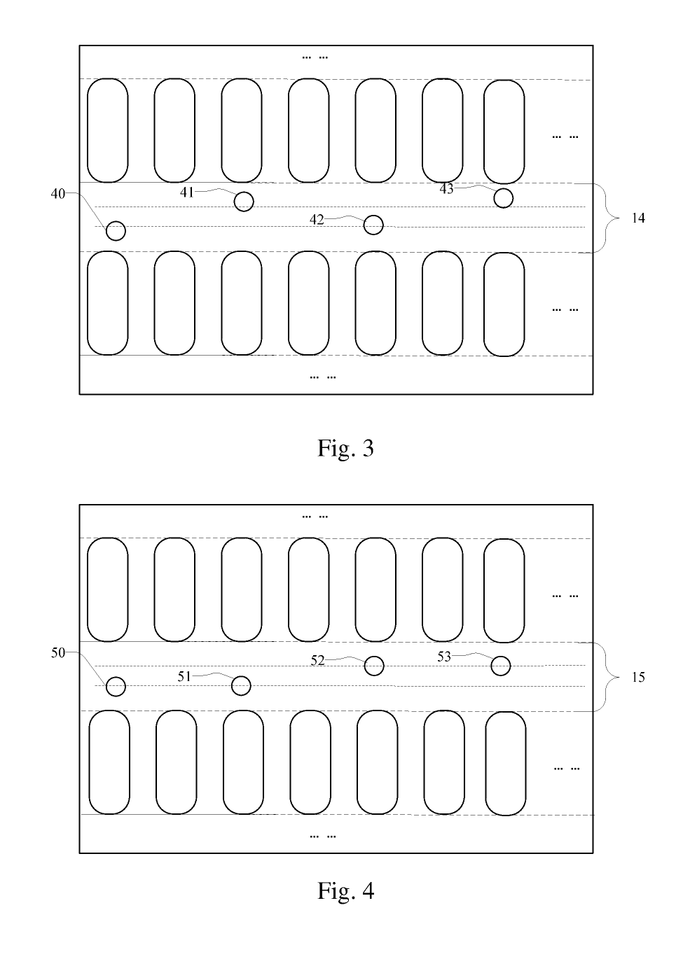

As shown in FIG. 2, a cross-section schematic view according to FIG. 1 taken along the A-A direction. As shown in Fig, there are rows of sub pixels arranged on a pixel area of the first substrate 1, such as 13a, 13b, 13c and etc. shown in the figure, and that combine a row of sub pixel 11 and a row of sub pixel 12.

A row of main supporting part 13 is arranged between two adjacent rows of sub pixels 11 and 12 (comprising main supporting part 20,21 and etc.), and in the main supporting parts, one portion of the main supporting parts and the other portion of the main supporting parts are misaligned a distance from each other along the horizontal direction. As shown in FIG. 2, a row of main supporting parts 13 is arranged between the adjacent sub pixels 11 and 12 (only a port of pixel area are shown in the figure, and only a portion of the row of the main supporting part are shown), and the adjacent main supporting parts 20 and 21 (or main supporting parts 30 and 31) are misaligned a distance D from each other. The above mentioned misaligned distance can be decided by the size of the LCD panel. Generally, the misaligned distance can be set to a distance of 2 to 4 micrometer in the perpendicular direction of the main supporting part 13 (as the perpendicular distance between the two horizontal lines shown in the figure). In the same substrate, the misaligned distance between the different main supporting parts can be the same or not. As shown in FIG. 3, the misaligned distance between the main supporting parts of row 14 of main supporting part can be selected by random.

Certainly, the main supporting parts 13 arranged between the adjacent sub pixels 11 and 12 also can misalign one misaligned distance by each two main supporting parts, or misalign one misaligned distance by each one main supporting part. As shown in FIG. 4, a condition in the row of main supporting part 15, two main supporting part is been as a unit (such as, main supporting parts 50 and 51 is as one unit, and main supporting parts 52 and 53 is as one unit), and the two units misalign one misaligned distance. For a person skilled in the art, a plurality of specific embodiments can be obtained, so it is not repeat described here.

Meanwhile, rows of the main supporting parts are combined by the main supporting parts between rows of the adjacent area of the sub pixels; two adjacent rows of the main supporting parts do not misaligned a distance along the perpendicular direction of the main supporting parts. As shown in FIG. 2, the main supporting parts 20 and 30 align along perpendicular direction, and the main supporting parts 21 and 31 also align along perpendicular direction.

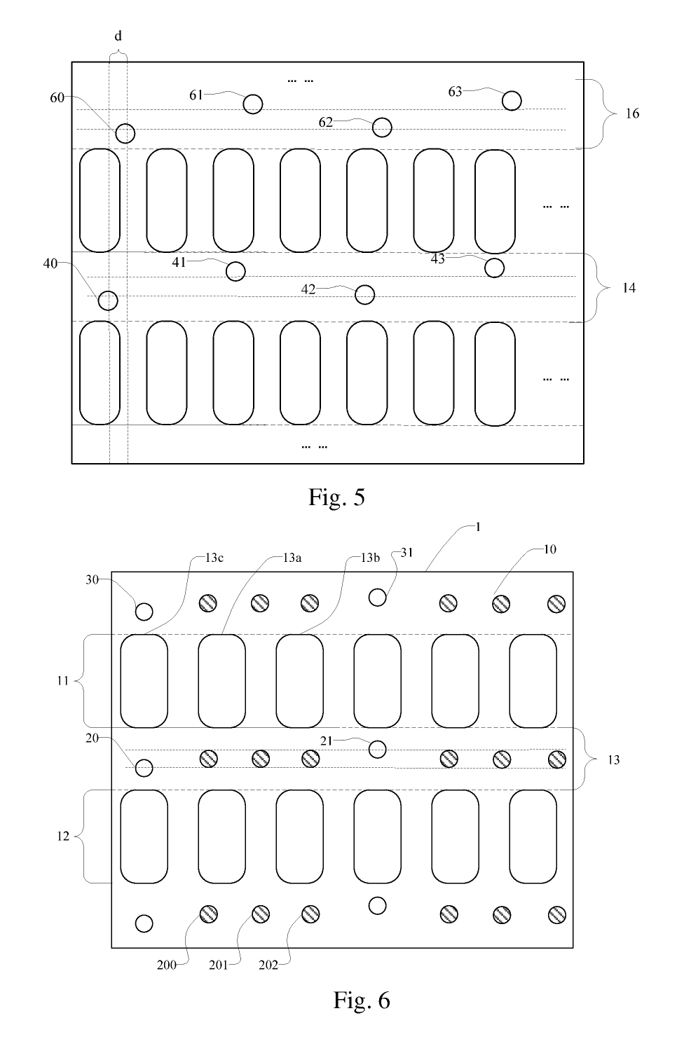

Certainly, the main supporting parts 20 and 30 also can misalign a distance along perpendicular direction as the dislocation of perpendicular direction, and the main supporting parts 21 and 31 also can misalign a distance. As shown in FIG. 5, a row of the main supporting part 14 and a row of the main supporting part 16 are misalign a distance along the perpendicular direction of the row, such as that the main supporting part 40 and the main supporting part 60 misalign a distance d.

As shown in FIG. 6, the LCD device further comprises sub supporting parts 200, 201, 202 and etc. (small circles with hatching in the figure). The sub supporting parts are arranged on one substrate of the first substrate or the second substrate, and extend toward to the other substrate but no touch with it. By the arrangement of the main supporting parts and the sub supporting parts, when it is suffered an external force in the perpendicular direction, the sub supporting parts can achieve a function of assisting support, so as to release the press of external force. As shown in FIG. 6, the sub supporting parts are arranged between the adjacent main supporting parts in a horizontal direction, and the number of the sub supporting parts is larger than the number of the main supporting parts. For example, there are n−1 numbers of the sub supporting parts arranged between the two main supporting parts in the horizontal direction. In this case, n>=3, and n is a natural number. As shown in FIG. 4, n=4.

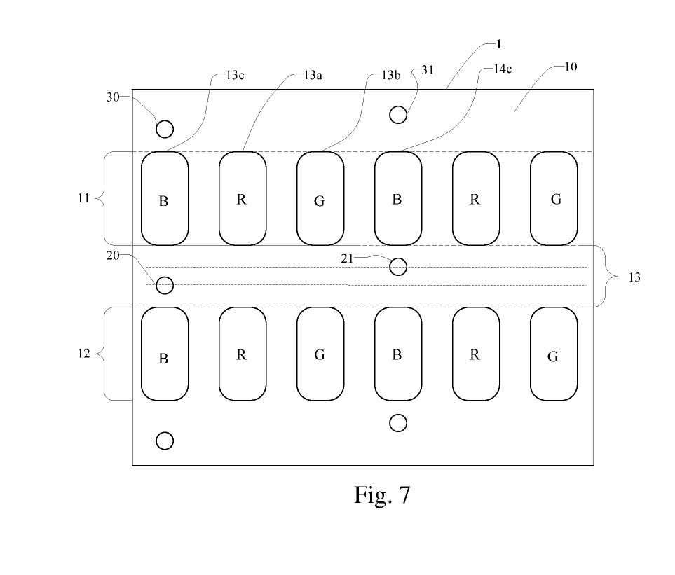

In the above mentioned embodiment, the first substrate can be a color filter substrate, and the sub pixels in the pixel area are color filters. The color filters can be arranged by a same color order. For example, a color filter substrate with B, R, G (Blue, Red, Green) three primary color, and are arranged by the same color order in FIG. 7. Certainly, the color filter substrate also can be B, R, G, Y (Yellow) four primary color filter, and so on. In a row of the main supporting part between two rows of adjacent color filters, each two main supporting parts space a distance of two color filters. As shown in FIG. 7, the main supporting part 20 and the adjacent main supporting part 21 of the row of the main supporting part 13 space one distance in two width of color filters 13a and 13b. Meanwhile, there are two sub supporting parts or five sub main supporting parts arranged between the adjacent main supporting parts 20 and 21.

In one of the specific embodiment according to the present invention, the material of the above mentioned main supporting parts can be the resin.

The LCD device according to the preferred embodiment of the present invention can solve the problem, when the LCD panel is pressed by an external force or the assembling accuracy of the upper/lower substrates is closed to a design tolerance, the LCD panel has an phenomenon of “Mura” or light leak. When the external force is removed, the pillars detached from the joint can return to a normal jointed condition to prevent the LCD panel from phenomenon of “Mura” or light leak, or to improve the recovering speed of display of the LCD panel, so as to improve the quality of the LCD panel. Meanwhile, the main supporting parts with misaligned or distributed arrangement can enhance the whole supporting stability. When the external force press produce a component force along the horizontal direction of the substrate, the pillars at or near the pressed location are possibly detached from a joint, and the misaligned manner of the pillars in the preferred embodiment of the present invention can make the detached main pillars quickly recover to a normal situation.

As described above, the present invention has been described with a preferred embodiment thereof and it is understood that many changes and modifications to the described embodiment can be carried out without departing from the scope and the spirit of the invention that is intended to be limited only by the appended claims.

Although the present invention has been described with reference to the preferred embodiment thereof, it is apparent to those skilled in the art that a variety of modifications and changes may be made without departing from the scope of the present invention which is intended to be defined by the appended claims.

1. A liquid crystal display (LCD) device, characterized in that: the LCD device comprises:
a first substrate and a second substrate opposite to each other, a liquid crystal layer filled between the first substrate and the second substrate, and a plurality of main supporting parts which are arranged between the first substrate and the second substrate;
wherein a pixel area is arranged on the first substrate; and
in the pixel area, the main supporting parts are arranged between two adjacent rows of sub pixels; and in the main supporting parts, one portion of the main supporting parts and the other portion of the main supporting parts are misaligned a distance from each other.

2. The LCD device according to claim 1, characterized in that: in the main supporting parts, one portion of the main supporting parts and the other portion of the main supporting parts are misaligned a distance from each other, wherein:
in the main supporting parts, two of the adjacent main supporting parts are misaligned a distance from each other.

3. The LCD device according to claim 1, characterized in that: the main supporting parts arranged between the rows of sub pixels construct rows of the main supporting parts; and
in the two adjacent rows of the main supporting parts, the main supporting parts are aligned to each other without displacement along the perpendicular direction of the rows of the main supporting parts.

4. The LCD device according to claim 1, characterized in that: the main supporting parts between the rows of sub pixels construct rows of the main supporting parts; and
in two adjacent rows of the main supporting part, the main supporting parts are misaligned to each other with a displacement along the perpendicular direction of the rows of the main supporting parts.

5. The LCD device according to any one of claim 1, characterized in that: the two misaligned main supporting parts are misaligned a distance of 2 to 4 micrometers in the perpendicular direction of the main supporting part.

6. The LCD device according to any one of claim 1, characterized in that: the LCD device further comprises sub supporting parts, wherein the sub supporting parts are arranged on the first substrate, extended toward the second substrate, and have a gap with the second substrate.

7. The LCD device according to any one of claim 1, characterized in that: the first substrate is a color filter substrate, and the sub pixels in the pixel area are R, G, B color filters.

8. The LCD device according to claim 7, characterized in that: in a row of the main supporting parts between two rows of the adjacent color filters, each two of the adjacent main supporting parts are spaced a distance of two color filters.

9. The LCD device according to claim 6, characterized in that: in a row of the main supporting parts, there are two of the sub supporting parts arranged between two of the adjacent main supporting parts.

10. The LCD device according to claim 6, characterized in that: five of the sub supporting parts are arranged between the adjacent main supporting parts.
